(19) United States
(12) Patent Application Publication
(10) Pub. No.: US 2026/0370293 A1
(43) Pub. Date: Nov. 19, 2026

(54) ONLINE INTER-ARRAY PHASE OFFSET COMPENSATION FOR MODULAR COVERAGE-ENHANCING DEVICES COMPRISING MULTIPLE PAIRS OF ANTENNA ARRAYS

(71) Applicant: Sony Group Corporation, Tokyo (JP)

(72) Inventors: Fredrik RUSEK, Eslöv (SE); Erik BENGTSSON, Eslöv (SE)

(21) Appl. No.: 19/142,890

(22) PCT Filed: Jan. 16, 2024
(86) PCT No.: PCT/EP2024/050848

§ 371 Date: Jun. 24, 2025

(30) Foreign Application Priority Data
Jan. 19, 2023 (SE) 2350046-5

(51) Int. Cl. H04B 7/06; H04B 7/026; H04B 7/04; H04B 7/08; H04B 7/155

(52) U.S. Cl. CPC H04B 7/0634; H04B 7/026; H04B 7/04013; H04B 7/0617; H04B 7/0691; H04B 7/0874; H04B 7/15528

(57) ABSTRACT

Techniques are disclosed for inter-array phase offset compensation at a modular coverage-enhancing device such as a network-controlled repeater (NCR). The modular coverage-enhancing device includes multiple modules, each module including multiple antenna arrays.

### TECHNICAL FIELD

Various examples of the disclosure generally pertain to coverage enhancing devices having multiple pairs of antenna arrays in a modular design. Various examples of the disclosure pertain to coverage enhancing devices performing measurements of inter-array phase offsets.

### BACKGROUND

To increase a coverage area for wireless communication, it is envisioned to use coverage-enhancing devices (CEDs), such as Network Controlled Repeaters (NCRs) or re-configurable relaying devices (RRDs). RRDs are sometimes also referred to as Reflective Intelligent Surfaces (RISs) or large intelligent surfaces (LISs). See, e.g., Huang, C., Zappone, A., Alexandropoulos, G. C., Debbah, M., & Yuen, C. (2019). Re-configurable intelligent surfaces for energy efficiency in wireless communication. IEEE Transactions on Wireless Communications, 18(8), 4157-4170. CEDs can generally also be referred to as network enhancement devices, since they generally enhance coverage, rank, and/or localizations.

An RRD may not possess the ability to provide a per-antenna gain; i.e., the antennas are semi-passive and do not amplify the antenna signal. It is possible to impose a variable phase shift per antenna, but not a variable amplitude gain. Differently, at least in some scenarios the NCR is configured to impose a variable amplitude gain for each antenna element.

A main differentiation between RRDs and NCRs relates to that in an NCR all signals received from the antenna elements of an antenna array are combined at some stage to form a single signal. Then they are re-distributed to the transmit antenna elements. For example, NCRs in the framework of the Third Generation Partnership Protocol (3GPP) are described in 3GPP TSG RAN Meeting #97-e RP-222673 (September 12-16, 2022).

Commonalities between RRDs and NCRs lay in that they both use large antenna arrays (also referred to as panels) with antennas and therefore are configured with spatial filters, to apply beamforming. Beamforming requires some algorithm to determine antenna phase shift values and optionally antenna gains.

In detail, for a CED, an input spatial direction (or simply, input direction) from which incident signals on a radio link are accepted by the CED and an output spatial direction (or simply, output direction) into which the incident signals are redirected by the CED can be re-configured by changing a phase relationship (and, where possible, amplitude relationship) between the antennas (and—where available—the per-antenna variable amplitude gain). This corresponds to configuring a spatial filter at the CED. This corresponds to beamforming. An input beam and an output beam are defined.

Scenarios are known in which the CED includes multiple pairs of input antenna arrays and output antenna arrays. The input antenna array of each pair is coupled to the output antenna array of the respective pair. The pair of antenna arrays and the coupling in-between the antenna arrays can be referred to as a module. Accordingly, such CED can be referred to as modular CED or multi-panel CED. Multiple modules contribute to beamforming of a single respective beam.

### SUMMARY

Techniques are required for controlling beamforming in modular CEDs.

This need is met by the features of the independent claims. The features of the dependent claims define embodiments.

Hereinafter, techniques of facilitating compensation of inter-array phase offsets at a modular CED that includes multiple pairs of antenna arrays are disclosed. These inter-array phase offsets correspond to different phases of signals at the respective antenna arrays.

According to various examples, a protocol for enabling determination and compensation the inter-array phase offsets can be triggered by a control node of the CED, e.g., by a base station (BS) of a cellular network.

The protocol can be conditionally triggered depending on one or more trigger criteria.

Such trigger criteria can include, but are not limited to: one or more communication devices (e.g., BSs, terminals, etc.) communicating via the CED being arranged in the near field of the CED; a rank of the communication between the communication devices communicating via the CED (the rank corresponding to a multi-antenna operation, e.g., multi-input multi-output, MIMO, operation); etc.

According to examples, the control node of the CED triggers the protocol for compensating the inter-array phase offsets.

According to examples, such triggering of the compensation includes configuring the CED with measurement durations for measuring inter-array phase offsets. During these measurement durations the CED can expect that certain signals—e.g., reference signals, also referred to as pilot signals—are arriving from the relevant communication devices such that the inter-array phase offsets can be measured.

The control node can also trigger communication devices that communicate via the CED to transmit these signals—e.g., reference signals—during the measurement durations.

First inter-array phase offsets can be associated with a first wireless communication device (simply, communication device) transmitting the first signals towards the CED and second measurement durations can be associated with a second communication device transmitting second signals towards the CED.

According to examples, the CED measures first inter-array phase offsets during the first measurement duration based on the first signals; and second inter-array phase offsets during the second measurement duration based on the second signal incident at the CED.

According to examples, measuring inter-array phase offsets includes measuring phase values of the incident signals at the CED at multiple antenna arrays. Differences in the phase values then correspond to the inter-array phase offsets.

According to examples, compensating the inter-array phase offsets includes applying with respective phase shifts at each antenna array that counteract the inter-array phase offsets. A method of operating a control node of a CED is disclosed. The CED includes multiple pairs of antenna arrays. A first wireless communication device—e.g., a base station or a terminal—and a second wireless communication device—e.g., a base station where a terminal—communicate via the CED. The method includes obtaining an indication of a capability from the CED. The indication of the capability indicates the capability of the CED to measure inter-array phase offsets in between the multiple pairs of antenna arrays. The method also includes configuring the CED with a first measurement duration based on the indication. The first measurement duration is for measuring first inter-array phase offsets for one or more first signals incident from the first wireless communication device. Furthermore, the method includes configuring the CED with a second measurement duration based on the indication. The second measurement duration is for measuring second inter-array phase offsets for one or more second signals that are incident from the second wireless communication device. Furthermore, the method includes triggering the first wireless communication device to transmit the one or more first signals during the first measurement duration and triggering the second wireless communication device to transmit the one or more second signals during the second measurement duration.

A computer program includes program code that can be loaded and executed by at least one processor. The at least one processor, upon loading and executing the program code, perform such method as described above.

A control node of a coverage-enhancing answer device includes a processor and a memory. The processor is configured to load program code from the memory and to execute the program code. The processor, upon executing the program code, is configured to obtain, from the CED, an indication of a capability of the CED to measure inter-array phase offsets in-between multiple pairs of antenna arrays. The processor is further configured to configure the CED with a first measurement duration for measuring first inter-array phase offsets for one or more first signal incident from a first wireless communication device based on the indication and to further configure the CED with a second measurement duration for measuring second inter-array phase offsets for one or more second signals that are incident from the second wireless communication device based on the indication. The processor is further configured to trigger the first wireless communication device to transmit the one or more first signals during the first measurement duration and to trigger the second wireless communication device to transmit the one or more second signals during the second measurement duration.

A method of operating a CED is disclosed. The CED includes multiple pairs of antenna arrays. A first wireless communication device and a second wireless communication device communicate via the CED. The method includes providing, to a control node of the CED, an indication of a capability to measure inter-array phase offsets in between the multiple pairs of antenna arrays.

A computer program includes program code that can be loaded and executed by at least one processor. The at least one processor, upon loading and executing the program code, perform such method as described above.

A CED includes multiple pairs of antenna arrays. The CED further includes a processor and a memory. The processor, upon loading program code from the memory and upon executing the program code, is configured to provide, to a control node of the CED, an indication of a capability to measure inter-array phase offsets in-between the multiple pairs of antenna arrays.

A method of operating a CED is disclosed. The CED includes multiple pairs of antenna arrays. A first wireless communication device and the second wireless communication device communicate via the CED. The method includes measuring first inter-array phase offsets for one or more first signals that are incident from the first wireless communication device during a first measurement duration. The method further includes measuring second inter-array phase offsets for one or more second signals that are incident from the second wireless communication device during a second measurement duration. The method also includes compensating the first inter-array phase offsets and compensating the second inter-array phase offsets when the first wireless communication device and the second wireless communication device communicate via the CED.

A computer program includes program code that can be loaded and executed by at least one processor. The at least one processor, upon loading and executing the program code, perform such method as described above.

A CED includes multiple pairs of antenna arrays, a processor, and a memory. The processor, upon loading program code from the memory and upon executing the program code is configured to measure first inter-array phase offsets for one or more first signals. The one or more first signals are incidental from a first wireless communication device during a first measurement duration. The at least one processor is further configured to measure second inter-array phase offsets for one or more second signals. The one or more second signals are incident from a second wireless communication device during a second measurement duration. The at least one processor is further configured to compensate the first inter-array phase offsets and the second inter-array phase offsets when the first wireless communication device and the second wireless communication device communicate via the CED.

A system includes a CED and a control node of the CED. The system may further include communication devices that communicate via the CED. The control node can be implemented by one of those configuration devices, e.g., by a base station of a cellular network.

It is to be understood that the features mentioned above and those yet to be explained below may be used not only in the respective combinations indicated, but also in other combinations or in isolation without departing from the scope of the disclosure.

### BRIEF DESCRIPTION OF THE DRAWINGS

FIG. 1 schematically illustrates a communication system including a BS, a CED, and a terminal according to various examples.

FIG. 2 schematically illustrates details with respect to a control circuitry of the CED according to various examples.

FIG. 3 schematically illustrates aspects with respect to radio-frequency circuitry of the CED according to various examples.

FIG. 4 is a flowchart of a method according to various examples.

FIG. 5 is a flowchart of a method according to various examples.

FIG. 6 schematically illustrates aspects with respect to the BS and the terminal of a communication system according to various examples.

FIG. 7 is a signaling diagram.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the disclosure will be described in detail with reference to the accompanying drawings. It is to be understood that the following description of embodiments is not to be taken in a limiting sense. The scope of the disclosure is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various examples of the disclosure pertain to a communication between a first communication device and a second communication device. The communication is via a CED. For example, the first communication device can be a BS of a cellular network, e.g., according to 3GPP specifications. The second communication device can be a terminal (also referred to as user equipment; UE) wirelessly connected to the BS. Other scenarios would be possible. For instance, the first communication device could be an access node of an ad-hoc network. Sidelink communication could also be supported by the CED. Hereinafter, however, for the sake of simplicity, a scenario will be disclosed in which a BS of a cellular network communicates with a UE via the CED. The techniques disclosed hereinafter can be readily applied to other scenarios.

Various examples of the disclosure pertain to a CED having a modular design. This means that the CED includes multiple pairs of antenna arrays. In principle, all antenna arrays observe the same propagation channel towards the BS and the UE. However, the observed propagation channels differ in the observed phase, due to the spatial offset of the antenna arrays with respect to each other. These phase differences between antenna arrays (inter-array phase offsets) lead to non-coherent over-the-air-superposition of the transmitted signals from the antenna arrays.

Various examples pertain to techniques to compensate the inter-array phase offsets. The inter-array phase offset compensation is carried out at the CED. The BS can assist in the inter-array phase offset compensation.

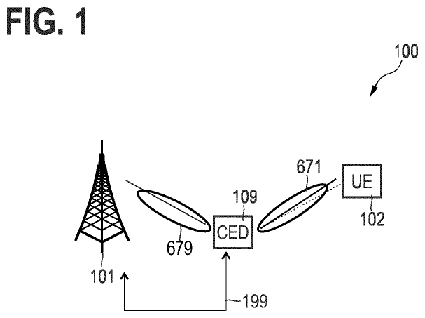

FIG. 1 illustrates an example communication system 100 that includes a CED 109 and a BS 101 as well as a UE 102. Illustrated is a beam 679 used by the CED 109 by appropriate beamforming to communicate with the BS 101. Also illustrated is a beam 671 used by the CED 109 to communicate with the UE 102. One or both of the beams 671, 679 can be formed by multiple respective antenna arrays/panels at the CED 109 (this will be explained later on in further detail).

As a general rule, communication can be in the uplink direction, i.e., from the UE 102 to the BS 101. In this scenario, the UE 102 is the transmitting communication device and the BS 101 is the receiving communication device. The beam 671 in this scenario is an input beam oriented along an input direction; while the beam 679 is an output beam oriented along an output direction.

It would also be possible to implement downlink communication from the BS 101 to the UE 102. In this scenario the BS 101 is the transmitting communication device and the UE 102 is the receiving communication device. The beam 679 is the input beam oriented along the input direction; while the beam 671 is the output beam oriented along the output direction.

For the sake of simplicity, hereinafter, scenarios will be described with respect to downlink communication; however, similar scenarios may be readily applied to uplink communication from the UE 102 to the BS 101, or sidelink communication between two UEs.

The respective orientations of the beam 671, 679—i.e., the target input and output directions—can be determined as part of beam sweeps or generally beam management procedures using reference techniques available in the prior art.

Also illustrated is a control link 199 between the BS 101 and the CED 109. The BS 101 can control the CED 109 via the control link 199. For instance, the BS 101 could provide one or more configuration or control messages to the CED 109; the CED 109 can provide configuration or control messages to the BS 101. The BS 101 can configure measurement durations that enable the CED 109 to measure inter-array phase offsets. The CED 109 can report to the BS 101, e.g., provide an indication of the inter-array phase offsets.

It is not required in all scenarios that the BS 101 implements the control node of the CED 109. In other scenarios, another node of the cellular network to which the BS 101 belongs can implement control functionality for the CED 109. For example, a UE 102 may alternatively or additionally implement control functionality for the CED 109. Also, a dedicated control node may be provisioned.

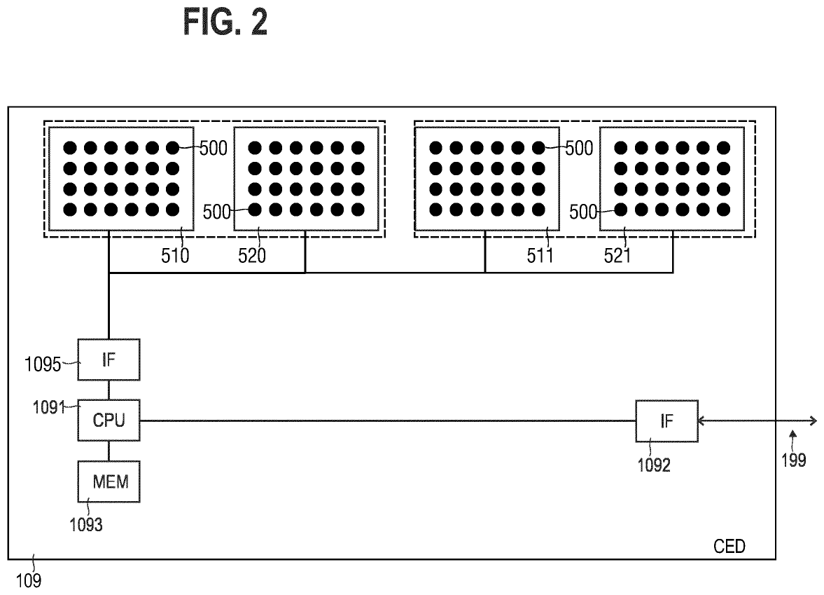

FIG. 2 schematically illustrates aspects with respect to the CED 109. A processor 1091 and a memory 1093 and a communication interface 1092 form a control circuitry of the CED 109. The CED 109 includes two pairs of antenna arrays 510, 511, 520, 521, each antenna array including multiple antenna elements 500 marked with full circles in FIG. 2 (while FIG. 2 only illustrates two pairs of an antenna arrays, as a general rule, more than two pairs of antenna arrays can be used). The antenna array 510 and the antenna array 520 form a first pair of antenna arrays (indicated in FIG. 2 by the dashed line). The antenna array 511 and the antenna array 521 form a second pair of antenna arrays. The antenna array 510 and the antenna array 511 implement input antenna arrays; i.e., phase shift values of phase shifters associated with the antenna elements 500 (or simply antennas) of the input antenna arrays 510, 511 are determined based on a value of an input direction. These phase shift values are determined to form the input beam 679 (cf. FIG. 1).

The antenna arrays 520, 521 implement output antenna arrays. The phase shift values of phase shifters associated with the antenna elements 500 of the output antenna arrays 520, 521 (the phase shifters are not shown in FIG. 2) are set to implement phase shift values that form the output beam 671 (cf. FIG. 1).

The phase shift values of the phase shifters associated with the antenna elements 500 can be re-configured by a processor 1091. This is to select the appropriate beam. For this, the processor 1091 can provide respective re-configuration commands via a communication interface 1095 to the antenna arrays 510, 520. For this, the processor 1091 can load program code from a memory 1093 and execute the program code and then based on the program code reconfigure the phase shift values. Also, if a variable gain can be applied per antenna, this can be re-configured by the processor 1091.

As a general rule, it would be possible that the pair of antenna arrays 510, 511 serves a first UE and the pair of antenna arrays 520, 521 serves another UE, located at a different position with respect to the CED 109 than the first UE. In such a scenario, different beams can be configured for the UE-facing antenna arrays of the different pairs. In some scenarios, however, the pairs of antenna arrays 510, 511 as well as 520, 521 serve one and the same UE. Here, the same beam is formed by both UE-facing antenna arrays. Such techniques are discussed herein. Specifically, it is discussed how coherent beamforming is possible across multiple antenna arrays. Thereby, multiple antenna arrays can cooperate to serve a single UE or a single communication device in general.

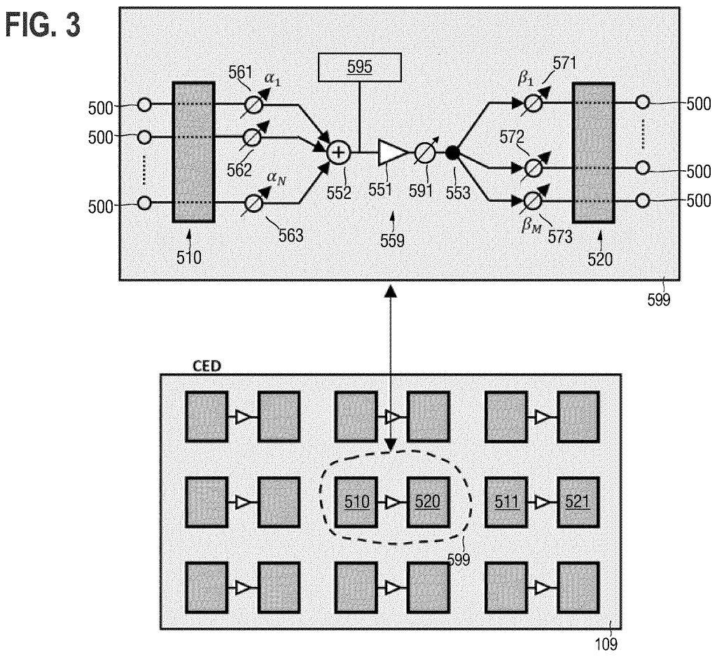

While FIG. 2 illustrates the control circuitry used to control the antenna arrays 510, 511, 520, 521, it does not show the radio-frequency (RF) components and a radiofrequency coupling between the antenna arrays of each pair. This is illustrated in FIG. 3.

FIG. 3 illustrates aspects with respect to RF components of the CED 109. FIG. 3 illustrates multiple modules 599 of the CED 109 (here a total of nine modules). One of these modules 599—the module 599 that includes the antenna arrays 510, 520—is shown at greater detail; the remaining modules 599 are all similarly configured.

The module 599 (detailed in the upper part of FIG. 3) includes the antenna array 510 and the antenna array 520 and a radiofrequency coupling 559 arranged in-between the antenna array 510 and the antenna array 520. The antenna array 510 receives signals, i.e., implements an input antenna array 510; and that the antenna array 520 transmits signals, i.e., implements an output antenna array 520.

To enable bi-directional communication, it would be possible to duplicate the RF coupling 559 or implement bidirectional RF components. Different modules can be devoted to uplink communication or downlink communication. Such assignment of a module to uplink communication or downlink communication, respectively, can be reconfigurable. For instance, the BS 101 or another control node of the CED 109 can reconfigure the CED 109 to allocate certain modules to uplink communication or downlink communication, respectively.

Each antenna element 500 is associated with a respective phase shifter 561, 562, 563 that applies respective phase shift values (labeled alpha). This defines the beamformer, i.e., the input beam 679. The phase shifter signals are then combined in a combining node 552 (this corresponds to an NCR implementation of the CED 109); then, there is provisioned a fixed-gain amplifier 551 (generally optional). The amplified signal is then split at node 553 and forwarded to phase shifters 571, 572, 573 associated with the antenna elements 500 of the output antenna array 520. This defines the beamformer of the output antenna array 520, i.e., the output beam 671.

Also illustrated is a global phase shifter 591 arranged in between the combining node 552 and the splitting node 553. The global phase shifter 591 is used in some scenarios to compensate for inter-array phase offsets, as will be explained in further detail hereinafter.

Alternatively, inter-array phase offsets can also be compensated using the antenna-specific phase shifters 561-563, 571-573.

Next, details with respect to the inter-array phase offsets will be explained. Considering two modules 599 (both configured for DL communication) and assuming that these two modules are equipped with the same beamforming pair (i.e., same input and output beams), one towards the BS 101 and one towards the UE 102.

The complex baseband representation of the signal received at the UE 102 is s(t)+exp(iα)s(t). The variable a represents the phase difference between the end-to-end signal paths via the two modules, i.e., α is the inter-array phase offset in-between these two modules. The value of α depends on the placement of the BS 101 and UE 102 in relation to the respective antenna arrays of the two modules.

The intention is to force α≈0 so that the signal-to-noise ratio at the UE 102 is maximized. This corresponds to compensation of the inter-array phase offset. Various techniques are available for compensating the inter-array phase offsets. In a first example, a factory/pre-compensation of the inter-array phase offsets is applied. Alternatively or additionally, an online compensation of the inter-array phase offsets is applied, i.e., during operation of the CED 109 with variable locations of the BS 101 and/or the UE 102 being taken into account.

Various techniques are based on the finding that a pre-compensation of inter-array phase offsets is difficult to achieve when the BS 101 and/or the UE 102 are in the near-field of the CED 109. Specifically for such scenarios an online compensation is desirable. This finding is explained in detail hereinafter.

The inter-array phase offset α is a consequence of the angles between the CED and the UE and BS (rather than the angles to which the beams point, e.g., the maximum of a beam profile).

For a factory/pre-compensation of the inter-array phase offset, the beams applied per module are phase adjusted so that α≈0 at fabrication/an end-of-line calibration. This applies if it is indeed true that the beams are accurately pointing towards the BS 101 and the UE 102, respectively. This means that where the same beams are applied and two different modules during operation, the intention is to apply inter-array phase offset compensated beam pairs using a factory-compensation. If such factory-compensation is made, then any α≠0 stems from the beams not pointing exactly at the BS 101 and the UE 102, respectively. For illustration, referring to FIG. 1, a scenario is disclosed in which the beam 671 is used to serve the UE 102; however, a maximum of the beam profile (illustrated by the full line in FIG. 1) is slightly offset from the actual direction of the UE 102 (illustrated by the dotted line in FIG. 1). To put it simply, the beam 671 does not point directly at the UE 102.

Assuming now that the BS 101 and the UE 102 are in the far-field of the CED 109. Then, we may assume that the beams point reasonably well towards the BS 101 and the UE 102, which implies that a is small if factory compensation is made. Perhaps even so small that no further compensation is necessary. An exception is when wide beams are used. Then, the whole point is that the devices are not well localized by the system in the angular domain, so that the factory compensated value may be far off the true one. But altogether it can be assumed that factory calibration works reasonably well when the far-field assumption holds.

Now assuming that the BS 101 and/or the UE 102 are in the near-field of the CED 109 (. Then, factory/pre-calibration becomes significantly more challenging or even impossible. If the beams applied at the modules point towards the same far-field angle then factory calibration is impossible, as the value a depends on the distance between the CED and the BS 101 and the UE 102, respectively.

Specifically, in the near field, the angle from the CED 109 towards the UE 102 (or, likewise, towards the BS 101) are different for each antenna array of the multiple modules of the CED. In other words, the spatial output direction used for beamforming differs from antenna array to antenna array.

Some degree of factory/pre-calibration can be made if the modules use different beams. From the sheer fact that two beams point in different directions, assumed locations of the UE and BS can be estimated and then factory calibration can be made. This yields, however, much larger values of a than those in the far-field case.

All this means that cases exist where modular CEDs are not phase coherent by design and online inter-array phase offset compensation according to the disclosure is helpful.

To enable an inter-array phase compensation during operation of the CED 109, the CED 109 includes a measurement unit 595 per module. Using the measurement unit 595, it is possible to measure the phase of the signal downstream of the combination node 552 and upstream of the splitting node 553 of the coupling 559, e.g., upstream of the amplifier 551 and the global phase shifter 591. Thus phase values per module can be measured.

The measurement unit 595 observes a time-continuous RF signal. The measurement unit 595 measures the average phase of the baseband signal contained in the RF signal over a certain time duration. The measurement units 595 of the multiple modules 599 of the CED 109 can coherently measure phases, i.e., with respect to the same reference.

As a general rule, various options are available for implementing the measurement unit 595. For instance, each module may include respective receiver circuitry, forming the respective measurement unit 595. In other scenarios, signals from two different modules may be compared with each other to measure the phase offset. Here, a signal combiner in combination with a power detector can be used. The particular hardware implementation of the measurement unit 595 is not germane for the techniques disclosed herein and various hardware implementations according to reference implementations can be relied upon.

In some hardware implementations, a calibration of the multiple measurement modules 595 of different modules may be required; so that phases with respect to the same reference are measured.

Furthermore, while in the scenario of FIG. 3 the measurement unit 595 is located upstream of the amplifier 551 (towards the input antenna array 510), in other scenarios it would be possible that the measurement unit 595 is located downstream of the amplifier 551 or even downstream of the phase shifter 591.

The measurement units 595 of the CED 109 enable the following protocol for online compensation of the inter-array phase offsets. Such protocol is described in further detail in connection with the following FIGs.

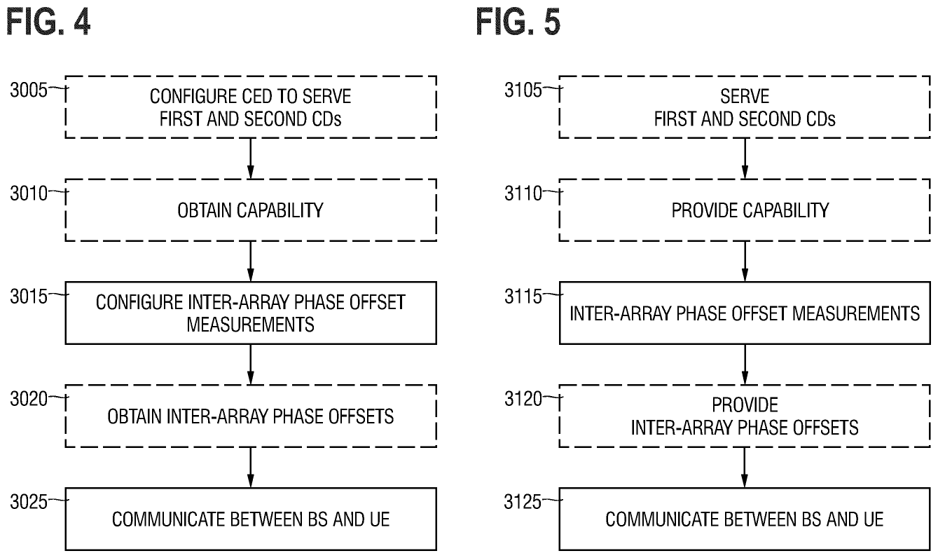

FIG. 4 is a flowchart of a method according to various examples. FIG. 4 illustrates a method for operating a control node of a CED. The control node can be implemented by a BS of a cellular network. The method of FIG. 4 is for use in the control node.

The method of FIG. 4 pertains to enabling online compensation of inter-array phase offsets of a modular CED such as the CED 109 discussed above in connection with FIG. 1, FIG. 2, and FIG. 3.

Optional boxes are shown with dashed lines

At box 3005, the CED is configured to serve a first communication device and a second communication device. This could also be pre-configured.

For the sake of simplicity, hereinafter it is assumed that the CED is configured to serve a BS and a UE such as the BS 101 and the UE 102 as discussed above. The CED is configured to apply respective beams, e.g., the beams 679 and 671 as discussed above in connection with FIG. 1.

Next, at box 3010, the control node obtains, from the CED, an indication of a capability of the CED to measure inter-array phase offsets in between multiple pairs of antenna arrays.

The capability message at box 3010 is generally optional. The capability could also be previously known or assumed by the control node.

Then, at box 3015, the control node triggers a protocol for measurement and compensation of inter-array phase offsets. Since this is at the time of deployment of the CED, it can be termed online compensation.

In some scenarios, it would be possible to conditionally execute the online compensation of the inter-array phase offsets at box 3015. I.e., the protocol can be triggered only responsive to certain circumstances (one or more trigger criteria). For instance, as one trigger criterion, it would be possible to detect that the UE and/or the BS are in a near field of the CED. Then, the online compensation of the inter-array phase offsets can be conditionally executed responsive to detecting that the BS and/or the UE are in the near field. Another example trigger criterion is whether the rank of the communication between the UE and the BS fulfills a criterion, e.g., is larger than two. For example, it could be checked whether different modules of the modular CED cooperate to serve a communication device using a single data stream. Here, a low rank communication (a single data stream) is used for multiple modules. In other scenarios, using multiple input multiple output (MIMO) techniques, multiple data streams may be used to obtain higher throughput and/or higher reliability, using spatial diversity. In such a scenario, an online compensation of inter-array phase offsets may not be required, because different antenna arrays are forwarding different data streams.

To detect whether the BS and/or the UE are in the near field of the CED, positioning techniques can be employed. Reference positioning techniques are available, e.g., in the 3GPP framework. Satellite positioning or multi-angulation using cellular signals can be employed.

Based on such positioning techniques, a distance between the CED and the BS and/or the UE can be determined. This distance can be compared to a threshold that defines whether or not the BS and/or the UE are located in the near field of the CED.

Box 3015 can include indicating to the CED that online compensation of the inter-array phase offsets should be carried out.

Box 3015 can include configuring the CED with a first measurement duration for measuring first inter-array phase offsets for first signals that are incident from the BS; as well as configuring the CED with a second measurement duration for measuring second inter-array phase offsets where second signals that are incident from the UE.

Box 3015 can include triggering the BS to transmit the first reference signals during the first measurement duration. For instance, where a separate control node of the CED is involved, this can include providing a respective control message to the BS. Where the BS itself implements the control node of the CED, this can include providing a respective command to associated layers of a transmission protocol stack of the BS. Thus, triggered by box 3015, the BS transmits a first reference signal towards the CED in the first measurement duration. During the first measurement duration, typically all modules of the CED are configured for downlink using the previously configured beam of box 3005 pointing towards the BS. The CED implements a phase measurement and the respective phase values recorded per module using the respective measurement unit (cf. FIG. 3: measurement unit 595). The recorded phase values are denoted θ_{1,m} where m refers to the module index. This corresponds to probing inter-array phase offsets of BS-facing antenna arrays.

Box 3015 can include triggering the UE to transmit the second signals during the second measurement duration. For instance, this can include a respective control message—e.g., a radio resource control (RRC) control message—being provided to the UE. During the second measurement duration, typically all modules of the CED are configured for uplink. A phase measurement is recorded per module of the CED. These are denoted as θ_{2,m} where m refers to the module index. The phase values are measured using the previously configured beam of box 3005 pointing towards the UE. This corresponds to probing inter-array phase offsets of UE-facing antenna arrays.

These measurements triggered by box 3015 enable the CED to measure the inter-array phase offsets. This measurement is based on a reference phase; the reference phase can be generally selected arbitrarily or one module is assigned as the reference module, say module m=1. Each inter-array phase offset (for all modules m) is given by as θ_{1,1}−θ_{1,m}+θ_{2,1}−θ_{2,m}.

In some examples, the CED reports, to the BS, the inter-array phase offsets determined for the various arrays. At box 3020, the BS can obtain, from the CED, in indication of the respective inter-array phase offsets.

Then, at box 3025, normal communication can commence. Here, typically, some modules are configured as UL and some as DL and normal operation commences; a compensation of the inter-array phase offsets is applied, e.g., using global phase shifters available in each module. The result is that, e.g., in the DL, all signals arrive in phase at the UE 102.

FIG. 5 is a flowchart of a method according to various examples. The method of FIG. 5 is for use in a CED. The method of FIG. 5 relates to operating a CED.

The method of FIG. 5 is directed to compensating inter-array phase offsets at the CED. As such, the method of FIG. 5 is interrelated to the method of FIG. 4 in that it is associated with the cooperation of the operation of the CED with the operation of the BS/the control node executing the method of FIG. 4.

At box 3105, the CED serves a first communication device and the second communication device. In other words, the first and second communication devices communicate via the CED. It is-for illustrative purposes-assumed that the first and second communication devices are a BS and a UE.

As explained above in connection with box 3005 of FIG. 4, it is possible that the control node configures the CED to serve the first and second communication devices. A respective configuration message can be obtained at the CED via a control link (cf. FIG. 2: control link 199).

At optional box 3110, the CED provides to the control node of the CED an indication of its capability to measure the inter-array phase offsets in-between the multiple pairs of antenna arrays. A respective control message can be provided by the CED via a control link (cf. FIG. 2: control link 199).

Box 3110 corresponds to and is interrelated with box 3010 of FIG. 4.

Next, at box 3115, inter-array phase offset measurements are executed. This includes being configured with a first measurement duration by the control node of the CED and being configured with a second measurement duration by the control node. Alternatively to such configuration of the first and second measurement durations, it would also be possible that the first and second measurement durations are fixedly preconfigured. For instance, they can be preconfigured in accordance with a repetitive timing schedule.

Furthermore, box 3115 includes measuring the first inter-array phase offsets for first reference signals that are incident from the BS during the first measurement duration, as well as measuring the second inter-array phase offsets for second signals that are incident from the UE during the second measurement duration. These measurements are executed using previously determined beams that are used for serving the BS and the UE, respectively; such beams can be configured at box 3105.

Optionally, variable gain amplifiers of the CED can be switched to an idle mode during the measurement durations. This would enable a reduction of noise in the measurements.

Then, once the inter-array phase offset measurements have been executed, the method commences at box 3120. Here, it is optionally possible to provide an indication of the inter-array phase offsets to the BS. Respective techniques have been discussed previously in connection with box 3020 of the method of FIG. 4.

Next, at box 3125, communication between the BS and the UE commences. This includes activating the respective beams that point towards the BS and the UE, respectively. Also, the first inter-array phase offsets are compensated and the second inter-array phase offsets are compensated. This includes applying the respective inter-array phase offsets using global phase shifters of each module.

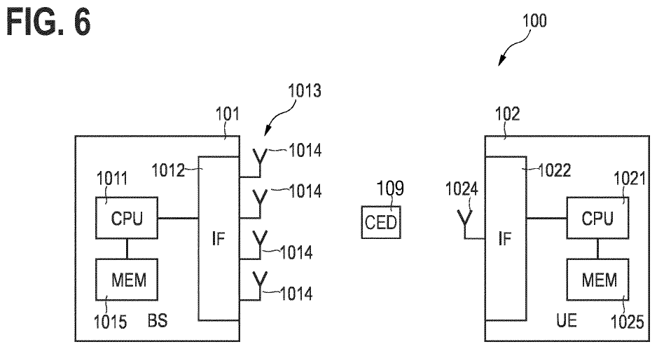

FIG. 6 schematically illustrates aspects in connection with the communication system 100 (cf. FIG. 1). FIG. 6 illustrates details with respect to the UE 102 and the BS 101.

The BS 101 includes a processor 1011 that can load program code from a memory 1015 and execute the program code. Executing the program code can cause the processor 1011 to perform techniques here as described herein, e.g.: configuring the CED 109, e.g., to execute a compensation of inter-array phase offsets, transmitting signals, e.g., reference signals (having a predetermined signal amplitude and shape) towards the CED 109; using beamforming to direct signals towards the CED 109; executing the method of FIG. 4, etc.

FIG. 6 illustrates details with respect to the UE 102. The UE 102 includes a processor 1021 and a memory 1025. The processor 1021 can load program code from the memory 1025 and execute the program code. Upon executing the program code, the processor can perform techniques as disclosed herein: e.g., receiving or transmitting signals via a wireless communication interface 1022 that accesses one or more antennas 1024; transmit signals, e.g., reference signals towards the CED 109, etc.

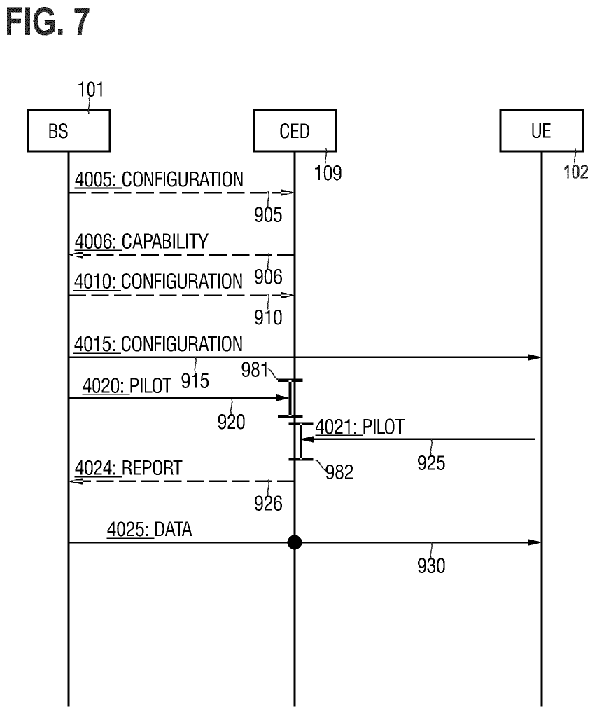

FIG. 7 is a signaling diagram of communication between BS 101 and the UE 102 and the CED 109. Communication using dashed lines is via the control link 199. Communication on a carrier of a cellular network to which the base station 101 belongs is illustrated using full lines.

The signaling of FIG. 7 can be used to implement the methods of FIG. 4 and FIG. 5.

In the scenario of FIG. 7 the BS 101 acts as control node for the CED 109. In other examples, another node can serve as control node. In this case, the dashed communication would be between the CED 109 and that other control node.

At 905, the BS 101 provides a configuration message 4005 to the CED 109, thereby configuring the CED 109 with beams towards the BS 101 and towards the UE 102 for communication on a carrier of the cellular network. For instance, the beam 679 towards the BS 101 and the beam 671 towards the UE 102 can be configured (cf. FIG. 1).

905, accordingly, implements box 3005 and box 3105 of the methods of FIG. 4 in FIG. 5, respectively.

Optionally, CED 109 can provide—at 906—its capability to make phase measurements using a respective control message 4006.

At 910, the BS 101 provides a configuration message to the CED 109, thereby configuring the CED 109 with measurement durations 981, 982.

Then, during the measurement duration 981, the BS 101, at 920, transmits one or more reference signals 4020 towards the CED 109 (e.g., using an appropriate beam pointing towards the CED 109). The CED 109 activates the beam configured using the configuration message 4005 at 905.

The UE 102, during the measurement duration 982, transmits one or more reference signals 4021 towards the CED 109, at 925. For this purpose, the UE 102 is accordingly configured with the measurement duration 982 using a configuration message 4015 transmitted by the BS 101 at 915. The UE 102 uses a beam pointing towards the CED 109. The CED 109, during the measurement duration 982, activates the beam pointing towards the UE 102 as configured using the configuration message 4005 at 905.

Accordingly, 910, 915, 920, 925 implement box 3015 and box 3115 according to the methods of FIG. 4 in FIG. 5, respectively. This implements box 3020 and box 3120 of the method of FIG. 4 and FIG. 5, respectively.

Optionally, the CED 109 can report on the inter-array phase of sets using a respective control message 4024 at 926.

Then, communication between the BS 101 and the UE 102 (illustrated in FIG. 7 is downlink communication, but uplink communication would be likewise possible) commences at box 930 where payload data 4025 is communicated. This communication is via the CED 109.

The CED applies the compensation of the inter-array phase offsets based on respective phase measurements implemented based on the reference signals 4020 and 4021. The beams configured at 905 are activated. This implements box 3025 and box 3125 of the method of FIG. 4 and FIG. 5, respectively.

Summarizing, techniques have been disclosed that facilitate compensation of inter-array phase offsets at a CED that includes multiple pairs of antenna arrays. These multiple pairs of antenna arrays cooperate to serve a single communication device, e.g., a UE or a base station. A respective modular CED has been described.

Various techniques have been disclosed that are based on the finding that inter-array phase offsets are based on, firstly, array geometry, as well as, secondly, input and output spatial directions. Since a beam is configured and the array geometry is known, ostensibly, no signaling to perform calibration would be required. However, the true spatial directions to a communication device may differ from the beam configuration, i.e., the direction of a maximum of the beam profile may differ from the actual direction at which a communication device is located. Corrections in the phases can be applied to compensate for corresponding inter-array phase offsets. Capability signaling is disclosed, e.g., to make sure that the CED is capable of performing such self-calibration of the inter-array phase offsets.

Summarizing, in particular the following EXAMPLE have been disclosed.

### EXAMPLE 1

A method of operating a control node (101) of a coverage-enhancing device (109) comprising multiple pairs of antenna arrays (510, 511, 520, 521), a first wireless communication device (101, 102) and a second wireless communication device (101, 102) communicating via the coverage-enhancing device (109),
wherein the method comprises:
   obtaining (3010), from the coverage-enhancing device (109), an indication of a capability to measure inter-array phase offsets in-between the multiple pairs of the antenna arrays (510, 511, 520, 521),
   based on the indication, configuring (3015) the coverage-enhancing device (109) with a first measurement duration (981, 982) for measuring first inter-array phase offsets for one or more first signals (4020, 4021) incident from the first wireless communication device (101, 102),
   based on the indication, configuring (3015) the coverage-enhancing device (109) with a second measurement duration (981, 982) for measuring second inter-array phase offsets for one or more second signals (4020, 4021) incident from the second wireless communication device (101, 102),
   triggering (3015) the first wireless communication device (101, 102) to transmit the one or more first signals (4020, 4021) during the first measurement duration (981, 982), and
   triggering (3015) the second wireless communication device (101, 102) to transmit the one or more second signals (4020, 4021) during the second measurement duration (981, 982).

### EXAMPLE 2

The method of EXAMPLE 1, further comprising:
obtaining (3020), from the coverage-enhancing device (109), an indication of the first inter-array phase offsets and the second inter-array phase offsets.

### EXAMPLE 3.

The method of EXAMPLE 1 or 2, further comprising:
configuring (3005) the coverage-enhancing device (109) to serve the first wireless communication device (101, 102) using a first beam (671, 679) and to serve the serve the second wireless communication device (101, 102) using a second beam (671, 679),
configuring the coverage-enhancing device (109) to measure the first inter-array phase offsets using the first beam (671, 679), and
configuring the coverage-enhancing device (109) to measure the second inter-array phase offsets using the second beam (671, 679).

### EXAMPLE 4

The method of any one of the preceding EXAMPLEs, further comprising:
detecting that the at least one of first wireless communication device (101, 102) or the second wireless communication device (101, 102) are in a near-field of the coverage-enhancing device (109),
wherein the first measurement duration (981, 982) and the second measurement duration (981, 982) are selectively configured responsive to detecting that the at least one of the first wireless communication device (101, 102) or the second wireless communication device (101, 102) are in the near-field of the coverage-enhancing device (109).

### EXAMPLE 5

A method of operating a coverage-enhancing device (109) comprising multiple pairs of antenna arrays (510, 511, 520, 521), a first wireless communication device (101, 102) and a second wireless communication device (101, 102) communicating via the coverage-enhancing device (109),
wherein the method comprises:
   providing, to a control node (101) of the coverage-enhancing device (109), an indication of a capability to measure inter-array phase offsets in-between the multiple pairs of the antenna arrays (510, 511, 520, 521).

### EXAMPLE 6

A method of operating a coverage-enhancing device (109) comprising multiple pairs of antenna arrays (510, 511, 520, 521), a first wireless communication device (101, 102) and a second wireless communication device (101, 102) communicating via the coverage-enhancing device (109),
wherein the method comprises:
   measuring (3115) first inter-array phase offsets for one or more first signals (4020, 4021) incident from the first wireless communication device (101, 102) during a first measurement duration (981, 982),
   measuring (3115) second inter-array phase offsets for one or more second signals (4020, 4021) incident from the second wireless communication device (101, 102) during a second measurement duration (981, 982), and
   compensating (3125) the first inter-array phase offsets and compensating the second inter-array phase offsets when the first wireless communication device (101, 102) and the second wireless communication device (101, 102) communicate via the coverage-enhancing device (109).

### EXAMPLE 7

The method of EXAMPLE 6, further comprising:
being configured, by a control node (101) of the coverage-enhancing device (109), with the first measurement duration (981, 982),
being configured, by the control node (101) of the coverage-enhancing device (109), with the second measurement duration (981, 982).

### EXAMPLE 8

The method of EXAMPLE 6 or 7, further comprising:
switching one or more variable-gain amplifiers to an idle mode during the first measurement duration (981, 982) and the second measurement duration (981, 982).

Although the disclosure has been shown and described with respect to certain preferred embodiments, equivalents and modifications will occur to others skilled in the art upon the reading and understanding of the specification. The present disclosure includes all such equivalents and modifications and is limited only by the scope of the appended claims.

For illustration, various techniques have been disclosed in which the inter-array phase offsets are compensated using global phase shifters (cf. FIG. 3: global phase shifter 591) that equally apply phase shifts to all antennas of the antenna arrays. Alternatively or additionally, it would be possible that the inter-array phase offsets are at least partially compensated by antenna-specific phase shifters (cf. FIG. 3: phase shifters 561, 562, 563, 571, 572, 573); here, the inter-array phase offsets can serve as a baseline for the respective antenna-specific phase shifters and the phase shift values associated with beamforming can be applied on top of these baselines.

For further illustration, various examples have been disclosed in connection with a scenario in which a BS communicates downlink data to a UE via the CED. Similar techniques may be readily employed for uplink communication or sidelink communication or other communication scenarios.

1. A method of operating a control node of a CED- comprising multiple pairs of antenna arrays, a first wireless communication device and a second wireless communication device communicating via the CED-, wherein the method comprises:
obtaining, from the CED-, an indication of a capability to measure interarray phase offsets in-between the multiple pairs of the antenna arrays.
based on the indication, configuring the CED- with a first measurement duration for measuring first inter-array phase offsets for one or more first signals incident from the first wireless communication device.
based on the indication, configuring the CED- with a second measurement duration for measuring second inter-array phase offsets for one or more second signals incident from the second wireless communication device,
triggering the first wireless communication device to transmit the one or more first signals during the first measurement duration, and
triggering the second wireless communication device to transmit the one or more second signals during the second measurement duration.

2. The method of claim 1, further comprising:
obtaining, from the CED-, an indication of the first inter-array phase offsets and the second inter-array phase offsets.

3. The method of claim 1, further comprising:
configuring the CED- to serve the first wireless communication device using a first beam and to serve the serve the second wireless communication device using a second beam,
configuring the CED- to measure the first inter-array phase offsets using the first beam, and
configuring the CED- to measure the second inter-array phase offsets using the second beam.

4. The method of claim 1, further comprising:
detecting that the at least one of first wireless communication device or the second wireless communication device are in a near-field of the CED-, wherein the first measurement duration and the second measurement duration are selectively configured responsive to detecting that the at least one of the first wireless communication device or the second wireless communication device are in the near-field of the CED-.

5. A method of operating a CED- comprising multiple pairs of antenna arrays, a first wireless communication device and a second wireless communication device communicating via the CED-, wherein the method comprises:
providing, to a control node of the CED- an indication of a capability to measure inter-array phase offsets in-between the multiple pairs of the antenna array.

6. A method of operating a CED- comprising multiple pairs of antenna arrays, a first wireless communication device and a second wireless communication device communicating via the CED-, wherein the method comprises:
measuring first inter-array phase offsets for one or more first signals incident from the first wireless communication device during a first measurement duration,
measuring second inter-array phase offsets for one or more second signals incident from the second wireless communication device during a second measurement duration, and
compensating the first inter-array phase offsets and compensating the second inter-array phase offsets when the first wireless communication device and the second wireless communication device communicate via the CED-.

7. The method of claim 6, further comprising:
being configured, by a control node of the CED-, with the first measurement duration,
being configured, by the control node of the CED-, with the second measurement duration.

8. The method of claim 6, further comprising:
switching one or more variable-gain amplifiers to an idle mode during the first measurement duration and the second measurement duration.

9-16. (canceled)
